(19) United States
(12) Patent Application Publication
(10) Pub. No.: US 2023/0102742 A1
(43) Pub. Date: Mar. 30, 2023

(54) TIMING ADVANCE ACQUISITION FOR MULTIPLE CELLS

(71) Applicant: MEDIATEK INC., Hsin-Chu (TW)

(72) Inventors: Li-Chuan Tseng, Hsin-Chu (TW); Chia-Hao Yu, Hsin-Chu (TW); Cheng-Rung Tsai, Hsin-Chu (TW); Chun-Fan Tsai, Hsin-Chu (TW); Jiann-Ching Guey, Hsin-Chu (TW)

(21) Appl. No.: 17/939,843

(22) Filed: Sep. 7, 2022

Related U.S. Application Data
(60) Provisional application No. 63/249,099, filed on Sep. 28, 2021.

(51) Int. Cl. H04W 74/08

(52) U.S. Cl. CPC H04W 74/0833

(57) ABSTRACT

A method of acquiring timing advance (TA) for neighbor cells to reduce latency and interruption for inter-cell mobility is proposed. A UE is configured with a set of active cells for fast cell-switching. To reduce handover interruption, UE performs early RACH for potential target cells and obtains the TA of the potential target cells. In one novel aspect, for overhead reduction, a single RACH preamble may be received by multiple cells. Using a single RACH preamble, UE acquires TA for multiple cells, aiming at reducing the interruption due to RACH during handover. In another novel aspect, UE reports DL reception timing difference between the serving cell and the neighbor cell, and then adjust the TA for the neighbor cell accordingly.

### CROSS REFERENCE TO RELATED APPLICATIONS

This application claims priority under 35 U.S.C. § 119 from U.S. Provisional Application No. 63/249,099, entitled “Timing Advance Acquisition for Multiple Cells”, filed on Sep. 28, 2021, the subject matter of which is incorporated herein by reference.

### TECHNICAL FIELD

The disclosed embodiments relate generally to wireless communication, and, more particularly, to a method for timing advance acquisition for multiple cells in 5G New Radio (NR) cellular communication networks.

### BACKGROUND

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. The next generation mobile network (NGMN) board has decided to focus the future NGMN activities on defining the end-to-end requirements for 5G new radio (NR) systems. In 5G NR, the base stations are also referred to as gNodeBs or gNBs.

Frequency bands for 5G NR are being separated into two different frequency ranges. Frequency Range 1 (FR1) includes sub-6 GHz frequency bands, some of which are bands traditionally used by previous standards, but has been extended to cover potential new spectrum offerings from 410 MHz to 7125 MHz. Frequency Range 2 (FR2) includes frequency bands from 24.25 GHz to 52.6 GHz. Bands in FR2 in this millimeter wave range have shorter range but higher available bandwidth than bands in FR1. For UEs in RRC Idle mode mobility, cell selection is the procedure through which a UE picks up a specific cell for initial registration after power on, and cell reselection is the mechanism to change cell after UE is camped on a cell and stays in idle mode. For UEs in RRC Connected mode mobility, handover is the procedure through which a UE hands over an ongoing session from the source gNB to a neighboring target gNB.

Data may be interrupted during handover for UE reconfiguration and synchronization. Random access (RA) is usually needed during handover, as one purpose of RA is for UE to obtain timing advance (TA) of the target cell. RA occasion appears periodically, and there is some uncertain delay before UE can send preamble. The random access response (RAR) also comes with some delay (within a window). For contention-based RA (CBRA), contention resolution failure causes further delay. In LTE, RACH-less handover is possible, but it is only applicable to the restrictive use cases where TA˜0 or the source TA can be reused for the target TA.

UE may acquire TA for potential target cells in advance. To avoid interruption, UE may need some gaps for RACH towards neighbor cells. If UE wants to acquire TA for multiple cells, it may not be able to find enough gaps, and the signaling overhead is also a problem. A solution is desired for UE to acquire TA for multiple cells in a single PRACH attempt.

### SUMMARY

A method of acquiring timing advance (TA) for neighbor cells to reduce latency and interruption for inter-cell mobility is proposed. A UE is configured with a set of active cells for fast cell-switching. To reduce handover interruption, UE performs early RACH for potential target cells and obtains the TA of the potential target cells. In one novel aspect, for overhead reduction, a single RACH preamble may be received by multiple cells. Using a single RACH preamble, UE acquires TA for multiple cells, aiming at reducing the interruption due to RACH during handover. In another novel aspect, UE reports DL reception timing difference between the serving cell and the neighbor cell, and then adjust the TA for the neighbor cell accordingly.

In one embodiment, a UE receives a configuration in a serving cell of a mobile communication network, wherein the configuration comprises information for performing an early random access channel (RACH) procedure with a neighbor cell. The UE obtains a downlink reception timing difference Δ between the serving cell and the neighbor cell. The UE transmits a RACH preamble to the network, wherein the UE obtains an estimated timing advance of the neighbor cell (TA′) derived from a random access response (RAR) from the neighbor cell. The UE acquires a timing advance of the neighbor cell (TA) by adjusting the estimated timing advance of the neighbor cell (TA′) using the downlink reception timing difference Δ, wherein TA=TA′+Δ.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G New Radio (NR) network supporting UE to acquire timing advance (TA) for multiple cells in one PRACH attempt in accordance with aspects of the current invention.

FIG. 2 illustrates simplified block diagrams of wireless devices, e.g., a UE and a gNB in accordance with embodiments of the current invention.

FIG. 3 illustrates a sequence flow of performing early synchronization towards potential target cell to reduce handover latency.

FIG. 4 illustrates the concept of RACH towards multiple cells, PRACH attempt, and PRACH occasion.

FIG. 5 illustrates the concept of RA occasion (RAO) and association with SSB in each cell.

FIG. 6 illustrates enhancement of using common RACH occasions (CRAO) for multiple cells.

FIG. 7 illustrates a first embodiment of TA adjustment for neighbor cells that are synchronized with the serving cell.

FIG. 8 illustrates a second embodiment of TA adjustment for neighbor cells that are not synchronized with the serving cell.

FIG. 9 illustrates a simplified method of acquiring TA for neighbor cells that are synchronized with the serving cell.

FIG. 10 is a flow chart of a method for TA acquisition for neighbor cells in accordance with one novel aspect.

### DETAILED DESCRIPTION

Reference will now be made in detail to some embodiments of the invention, examples of which are illustrated in the accompanying drawings.

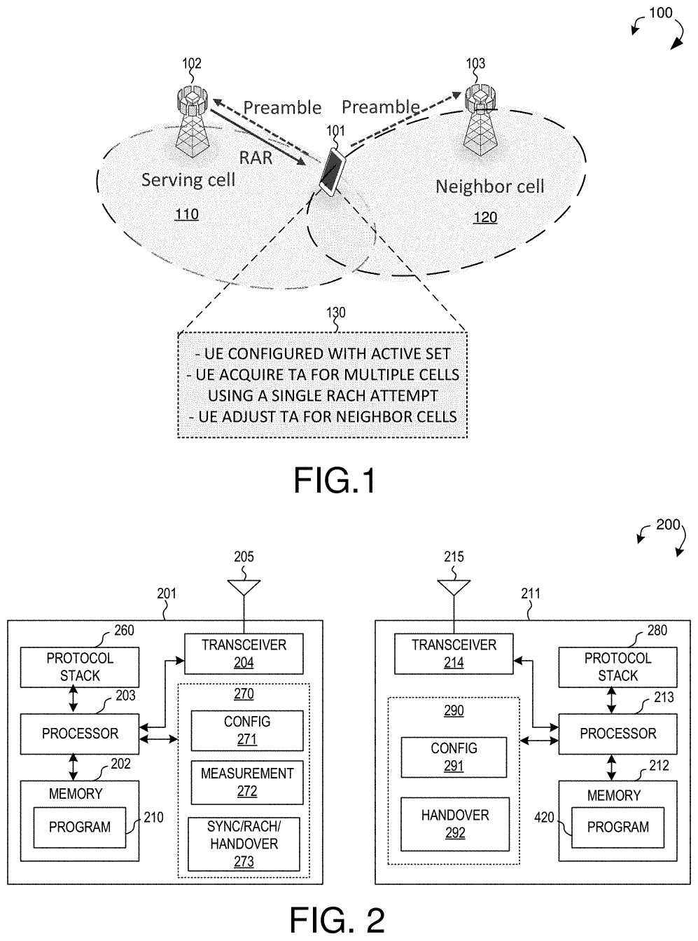

FIG. 1 illustrates an exemplary 5G New Radio (NR) network 100 supporting UE to acquire timing advance (TA) for multiple cells in one PRACH attempt in accordance with aspects of the current invention. The 5G NR network 100 comprises a User Equipment (UE) 101 and a plurality of base stations including gNB 102, and gNB 103. UE 101 is communicatively connected to a serving gNB 102, which provides radio access using a Radio Access Technology (RAT) (e.g., the 5G NR technology). The UE 101 may be a smart phone, a wearable device, an Internet of Things (IoT) device, and a tablet, etc. Alternatively, UE 101 may be a Notebook (NB) or Personal Computer (PC) inserted or installed with a data card which includes a modem and RF transceiver(s) to provide the functionality of wireless communication.

The 5G core function receives all connection and session related information and is responsible for connection and mobility management tasks. For UEs in radio resource control (RRC) Idle mode mobility, cell selection is the procedure through which a UE picks up a specific cell for initial registration after power on, and cell reselection is the mechanism to change cell after UE is camped on a cell and stays in idle mode. For UEs in RRC Connected mode mobility, handover is the procedure through which a UE hands over an ongoing session from the source gNB to a neighboring target gNB. UE 101 is not always served by the best cell/beam due to mobility latency, which is due to the time spent on measurement report, handover command, and handover execution. Data may be interrupted during handover for UE reconfiguration and synchronization. In case of short cell/beam dwelling time (e.g., in FR2), the percentage of time when UE is served by an inferior cell/beam, or with service interruption, can be significant.

Random access (RA) is usually needed during handover, as one purpose of RA is for UE to obtain timing advance (TA) of the target cell. RA occasion appears periodically, and there is some uncertain delay before UE can send preamble. The random access response (RAR) also comes with some delay (within a window). For contention- based RA (CBRA), contention resolution failure causes further delay. In LTE, RACH-less handover is possible, but it is only applicable to the restrictive use cases where TA˜0 or the source TA can be reused for the target TA. UE may acquire TA for potential target cells in advance. To avoid interruption, UE may need some gaps for RACH towards neighbor cells. If UE wants to acquire TA for multiple cells, it may not be able to find enough gaps, and the signaling overhead is also a problem.

In accordance with one novel aspect, a method of acquiring timing advance (TA) for neighboring cells in one PRACH attempt to reduce handover latency and interruption is proposed (as depicted in 130). In dense deployment (e.g., for FR2), UE 101 is configured with a set of active cells. For the active set, UE 101 can do fast switching among the active cells. A non-serving active cell in the active set is likely to become a target cell for handover, and UE 101 can switch to the target cell in the active set via a low-latency network handover signaling (e.g., L1 or MAC signaling). To reduce handover interruption, UE 101 can acquire TA corresponding to the cells in the active set before handover. In one novel aspect, for overhead reduction, a single preamble may be received by multiple cells. Using a single preamble, UE 101 acquires TA for multiple cells, aiming at reducing the interruption due to RA during handover. In another novel aspect, UE 101 reports DL reception timing difference between the serving cell and the neighbor cell, and then adjust the TA for the neighbor cell accordingly.

FIG. 2 illustrates simplified block diagrams of wireless devices, e.g., a UE 201 and a gNB 211 in accordance with embodiments of the current invention in 5G NR network 200. The gNB 211 has an antenna 215, which transmits and receives radio signals. An RF transceiver module 214, coupled with the antenna 215, receives RF signals from the antenna 215, converts them to baseband signals and sends them to the processor 213. The RF transceiver 214 also converts received baseband signals from the processor 213, converts them to RF signals, and sends out to the antenna 215. The processor 213 processes the received baseband signals and invokes different functional modules to perform features in the gNB 211. The memory 212 stores program instructions and data 220 to control the operations of the gNB 211. In the example of FIG. 2, the gNB 211 also includes a protocol stack 280 and a set of control function modules and circuits 290. The protocol stack 280 may include a Non-Access-Stratum (NAS) layer to communicate with an AMF/SMF/MME entity connecting to the core network, a Radio Resource Control (RRC) layer for high layer configuration and control, a Packet Data Convergence Protocol/Radio Link Control (PDCP/RLC) layer, a Media Access Control (MAC) layer, and a Physical (PHY) layer. In one example, the control function modules and circuits 290 include a configuration circuit for configuring measurement report and active set for UE, and a handover handling circuit for sending cell-switch to the UE upon handover decision.

Similarly, the UE 201 has a memory 202, a processor 203, and an RF transceiver module 204. The RF transceiver 204 is coupled with the antenna 405, receives RF signals from the antenna 205, converts them to baseband signals, and sends them to the processor 203. The RF transceiver 204 also converts received baseband signals from the processor 203, converts them to RF signals, and sends out to the antenna 205. The processor 203 processes the received baseband signals (e.g., comprising cell addition/activation commands) and invokes different functional modules and circuits to perform features in the UE 201. The memory 202 stores data and program instructions 210 to be executed by the processor 203 to control the operations of the UE 201. Suitable processors include, by way of example, a special purpose processor, a Digital Signal Processor (DSP), a plurality of micro-processors, one or more micro-processor associated with a DSP core, a controller, a microcontroller, Application Specific Integrated Circuits (ASICs), File Programmable Gate Array (FPGA) circuits, and other type of Integrated Circuits (ICs), and/or state machines. A processor in associated with software may be used to implement and configure features of the UE 201.

The UE 201 also includes a protocol stack 260 and a set of control function modules and circuits 270. The protocol stack 260 may include a NAS layer to communicate with an AMF/SMF/MME entity connecting to the core network, an RRC layer for high layer configuration and control, a PDCP/RLC layer, a MAC layer, and a PHY layer. The Control function modules and circuits 270 may be implemented and configured by software, firmware, hardware, and/or combination thereof. The control function modules and circuits 270, when executed by the processor 203 via program instructions contained in the memory 202, interwork with each other to allow the UE 201 to perform embodiments and functional tasks and features in the network. In one example, the control function modules and circuits 270 include a configuration circuit 271 for obtaining configuration information of active set and pre-RACH, a measurement circuit 272 for performing and reporting measurements, and a sync/RACH/handover handling circuit 273 for performing (pre)-synchronization, (pre)-RACH, and handover procedure based on the configuration and HO command received from the network.

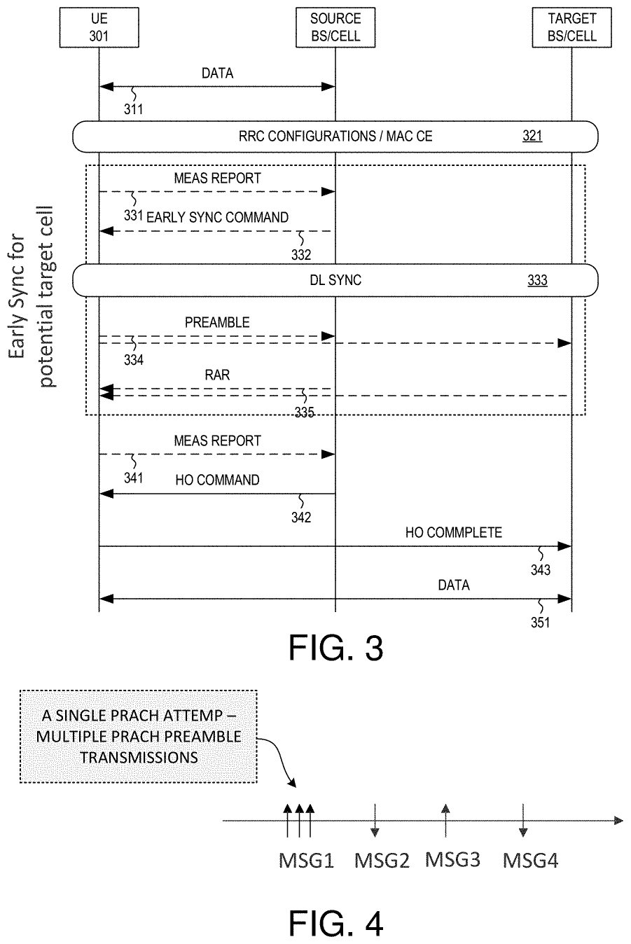

FIG. 3 illustrates a sequence flow of performing early synchronization towards potential target cell to reduce handover latency. In step 311, UE 301 performs data transmission and reception with a serving base station in a serving cell. In step 321, the source gNB provides RRC configuration /MAC CE to UE 301 for a set of configured cells and/or active cells. The RRC configurations comprise information for UE to perform DL and UL synchronization on the active cells (i.e., potential target cells), and common and dedicated configurations required when the active cell becomes UEs' serving cell.

In step 331, UE 301 performs measurements and sends measurement report of the configured/active cells to the serving gNB. In step 332, UE 301 receives an early sync command from the serving gNB, e.g., a PDCCH order, which triggers early synchronization for UE 301 with one or more neighbor cells. The early synchronization may also be triggered by the RRC configuration or MAC CE directly, e.g., in step 321. In the downlink, UE 301 performs downlink synchronization and fine time-frequency tracking for at least some beams of the active cells (step 333). In the uplink, UE 301 performs pre-RACH for timing advance acquisition of the active cells. In step 334, UE 301 performs uplink synchronization by sending a preamble to the neighbor cells. In step 335, UE 301 monitors RAR from the neighbor cells and thereby acquires the TA accordingly. The DL reception timing reference for transmitting the PRACH may be based on a serving cell, or based on the neighbor cell.

The RACH procedure should be a contention-free random access (CFRA) procedure. In CFRA, the Preamble is allocated by the gNodeB, and such preambles are known as dedicated random access preamble. The dedicated preamble is provided to UE either via RRC signaling (allocating preamble can be specified within an RRC message) or PHY Layer signaling (DCI on the PDCCH), e.g., SSB index and preamble index. Therefore, there is no preamble conflict. When dedicated resources are insufficient, the gNodeB instructs UEs to initiate contention-based RA. CFRA is also known as three step RACH procedure: Step 1—Random Access Preamble Assignment; Step 2—Random Access Preamble Transmission (Msg1); Step 3—Random Access Response (RAR) (Msg2), which contains TA information. After the RACH procedure, UE 301 acquires the TA for the active cells, but does not change serving cell immediately.

In step 341, UE 301 performs measurements of neighboring cells and sends measurement report to the serving gNB. In step 342, the serving gNB makes cell-switching decisions based on the measurement report, and sends an HO command message to UE 301. Upon receiving the HO command, UE 301 applies target cell configuration. The HO command can be L1/L2/L3 signal. In step 343, UE 301 sends an HO complete message to the target gNB, and the handover procedure is completed. In step 351, UE 301 starts data transmission and reception in the target cell. Because UE maintains the target cell configuration, and performs synchronization and acquires the TA with the active cell before receiving the HO command, and because the HO command indicates the active cell as the target cell, handover can be as fast as beam switching and HO interruption time is reduced.

FIG. 4 illustrates the concept of PRACH towards multiple cells, PRACH attempt, and PRACH occasion. It has been observed that a single PRACH transmission can be received by multiple cells, e.g., in FR1. More than one PRACH transmissions may be needed for being received by multiple cells, e.g., in FR2. Different PRACH transmission may need to be transmitted by different UE beams, e.g., beam-sweeping. Depending on UE implementation, each of the multiple PRACH transmissions may correspond to different UE beams. The number of PRACH occasions in a PRACH attempt may be signaled by the network.

For a single PRACH attempt, multiple PRACH occasions are provided. As depicted in FIG. 4, a single PRACH attempt is implemented with three PRACH transmissions over three PRACH occasions for Msg1. From RACH procedure perspective, this at least impacts Msg1 transmission. That is, Msg1 transmission with a single PRACH is now translated to a single PRACH attempt (but with one or more than one actual PRACH transmissions). Network may differentiate between a preamble targeting for serving cell only and a preamble targeting for multiple cells. UE may receive one or multiple RAR corresponding to the last PRACH attempt. UE may receive one RAR, which corresponds to the serving cell or to a neighbor cell. UE may receive multiple RAR, which corresponds to the serving cell or neighbor cells that received the last PRACH attempt. UE sets the TA for the serving cell and/or neighbor cells according to the received RAR.

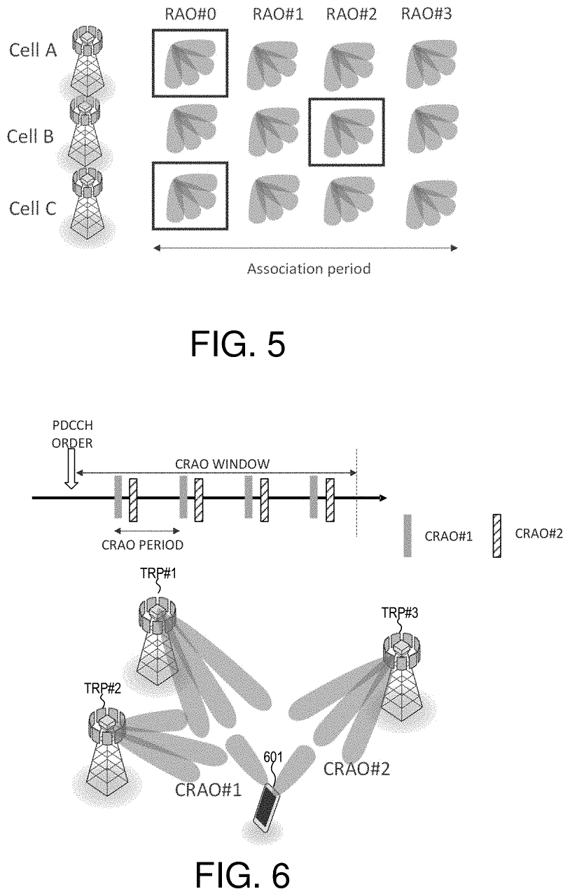

FIG. 5 illustrates the concept of RA occasion (RAO) and association with synchronization signal block (SSB) in each cell. PRACH preambles need to be sent on pre-defined RA occasions (RAOs). RA occasions are associated with SSB beams in each cell. SSB beams are static or semi static, always pointing to the same direction. Preamble is sent using UE beam pointing towards gNB and received using gNB beam pointing towards UE. Reusing existing RA occasions for multiple cells is preferred. Preamble sent on a RA occasion of one cell may be received by another cell if 1) RA occasions are aligned; 2) the SSB beam of another cell also points towards UE direction, and 3) UE beam points towards both cells. Otherwise, UE may need to send multiple preambles. As illustrated in FIG. 5, the RA occasions of all three cells are aligned. UE sends one preamble on RAO #0, received by Cell A and Cell C. TA of Cell C needs to be adjusted if the preamble is sent using Cell A timing. UE sends another preamble on RAO #2 to Cell B, using Cell B timing.

FIG. 6 illustrates enhancement of using common RACH occasions (CRAO) for PRACH to multiple cells. To facilitate RACH occasions that can be monitored by many cells, a Common RACH Occasions (CRAO) is defined for multiple cells. In each CRAO, the gNB beam is decided by each cell, there is no pre-defined association. As depicted in FIG. 6, CRAOs may appear periodically within a CRAO window after the PDCCH order. There may be multiple occasions in each CRAO period. For each indicated CRAO, UE may select one occasion in the CRAO window for preamble transmission. The CRAO window length and the location of the occasions are provided by the network to UE (e.g., as a configuration index).

The number of occasions with actual PRACH transmission may be dependent on UE DL measurements on neighboring transmission points (TRPs). For example, in FIG. 6, UE 601 may decide a first PRACH transmission in CRAO #1 is targeted for TRP #1 and TRP #2, and a second PRRACH transmission in CRAO #2 targeting for TRP #3 is needed because of spatial direction difference of the TRPs. In one case, the first PRACH transmission may be based on DL reception timing of TRP #1, and the second PRACH transmission may be based on DL reception timing of TRP #3. For example, UE 601 may decide a single PRACH transmission in CRAO #1 targeting for TRP #1 and TRP #2 is enough. No further PRACH transmission in a PRACH attempt is performed. A UE capability signaling may be sent to the network indicating UE preference on the number of PRACH occasions in a PRACH attempt.

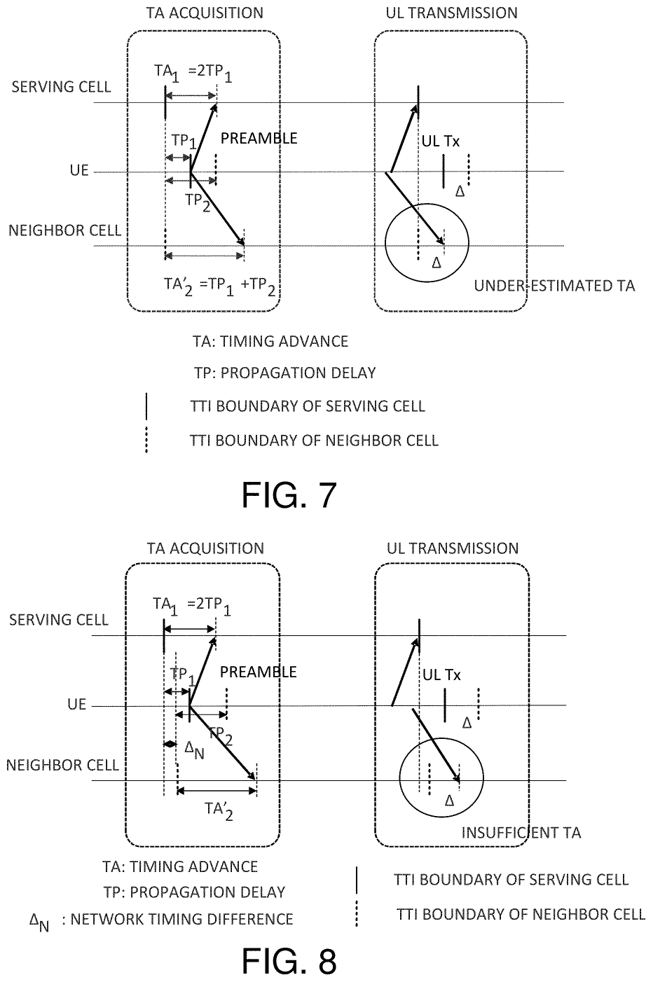

FIG. 7 illustrates a first embodiment of TA adjustment for neighbor cells that are synchronized with the serving cell. The DL reception timing reference for transmitting the PRACH is based on a reference cell. The reference cell can be the serving cell or one of the neighbor cells. Other cells need to adjust TA estimated based on this PRACH. The timing advance (TA) of a neighbor cell is estimated by the network based on the corresponding propagation delay (TP) of the PRACH preamble transmitted from the UE. In theory, TA=2TP, e.g., the timing advance is twice the propagation delay. However, the TA estimated by a neighbor cell based on the PRACH transmitted in a reference cell needs to be adjusted by the DL reception timing reference between the reference cell and the neighbor cell.

In the example of FIG. 7, the PRACH preamble transmission is based on the serving cell acting as the DL reception timing reference cell. Assume that the neighbor cell is synchronized with the serving cell, e.g., the TTI boundary for the serving cell and neighbor cell is the same. The propagation delay for the serving cell is TP₁, and the propagation delay for the neighbor cell is TP₂. Without loss of generosity, we assume that TP₂>TP₁. From UE perspective, the DL reception timing difference between the two cells is Δ=TP₂−TP₁. For TA acquisition, the serving cell estimates that TA₁=2TP₁, the neighbor cell estimates that TA′₂=TP₁+TP₂. Because the preamble transmission is based on the serving cell DL reception timing as reference, the estimated TA′₂ for neighbor cell is under-estimated, and needs to be adjusted with the DL reception timing difference Δ=TP₂−TP₁ reported by the UE. After adjustment, TA₂=TA′₂+Δ=2TP₂. The report signaling can be MAC-CE or RRC.

FIG. 8 illustrates a second embodiment of TA adjustment for neighbor cells that are not synchronized with the serving cell. In the example of FIG. 8, the PRACH preamble transmission is also based on the serving cell acting as the DL reception timing reference cell. Suppose that the network timing difference between the serving cell and the neighbor cell is Δ_{N}, e.g., the TTI boundary for the serving cell and neighbor cell is separated by Δ_{N}. The propagation delay for the serving cell is TP″, and the propagation delay for the neighbor cell is TP₂. From UE perspective, the UE calculates the DL reception timing difference between the two cells is Δ=TP₂+Δ_{N}−TP₁. For TA acquisition, the serving cell estimates that TA₁=2TP₁, the neighbor cell estimates that TA′₂=TP₁+TP₂−Δ_{N}. Because the preamble transmission is based on the serving cell DL reception timing as reference, the estimated TA′₂ for neighbor cell is insufficient, and needs to be adjusted with the DL reception timing difference Δ=TP₂+Δ_{N}−TP₁ reported by the UE. After adjustment, TA₂=TA′₂+Δ=2TP₂. The correction for TA₂ does not depend on the network timing difference Δ_{N}.

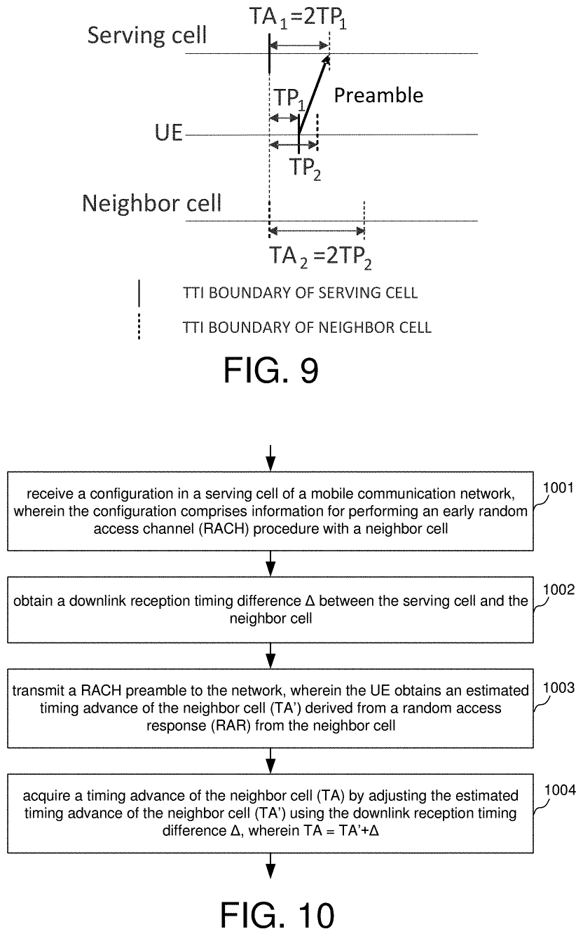

FIG. 9 illustrates a simplified method of acquiring TA for neighbor cells that are synchronized with the serving cell. For synchronous network, the TTI boundary for the serving cell and neighbor cell is the same. It has been observed that the TA towards a neighbor cell (TA₂) may be derived from the serving cell TA (TA₁) and the DL reception time difference between the serving cell and the neighbor cell (Δ=TP₂−TP₁). This is because for synchronous network, TA₂=2TP₂=2TP₁+2(TP₂−TP₁)=TA₁+2·Δ. Therefore, the network can indicate UE to use DL reception time difference for neighbor cell TA estimation (implicitly telling UE that the network is synchronous), without relying on a separate RACH procedure. If the DL reception time difference is calculated by UE, then the neighbor cell does not need to estimate TA using PRACH preamble. UE only needs to perform RACH toward the serving cell and receive TA command for the serving cell (TA₁).

FIG. 10 is a flow chart of a method for TA acquisition for neighbor cells in accordance with one novel aspect. In step 1001, a UE receives a configuration in a serving cell of a mobile communication network, wherein the configuration comprises information for performing an early random access channel (RACH) procedure with a neighbor cell. In step 1002, the UE obtains a downlink reception timing difference A between the serving cell and the neighbor cell. In step 1003, the UE transmits a RACH preamble to the network, wherein the UE obtains an estimated timing advance of the neighbor cell (TA′) derived from a random access response (RAR) from the neighbor cell. In step 1004, the UE acquires a timing advance of the neighbor cell (TA) by adjusting the estimated timing advance of the neighbor cell using the downlink reception timing difference A, wherein TA=TA′+Δ.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving a configuration by a User Equipment (UE) in a serving cell of a mobile communication network, wherein the configuration comprises information for performing an early random access channel (RACH) procedure with a neighbor cell;
obtaining a downlink reception timing difference Δ between the serving cell and the neighbor cell;
transmitting a RACH preamble to the network, wherein the UE obtains an estimated timing advance of the neighbor cell (TA′) derived from a random access response (RAR) from the neighbor cell; and
acquiring a timing advance of the neighbor cell (TA) by adjusting the estimated timing advance of the neighbor cell (TA′) using the downlink reception timing difference Δ, wherein TA=TA′+Δ.

2. The method of claim 1, wherein the downlink reception timing difference Δ is equal to a propagation delay of the neighbor cell (TP₂) minus a propagation delay of the serving cell (TP₁).

3. The method of claim 2, wherein the estimated TA of the of the neighbor cell TA′=TP₁+TP₂ and the downlink reception timing difference Δ=TP₂−TP₁, if the serving cell and the neighbor cell are synchronized.

4. The method of claim 3, wherein the TA of the neighbor cell can be obtained from TP₁ and A without relying on the RAR from the neighbor cell, wherein TA=2TP₁+2Δ.

5. The method of claim 2, wherein the estimated TA of the of the neighbor cell TA′=TP₁+TP₂−Δ_{N} if the serving cell and the neighbor cell are not synchronized, and Δ_{N} is the network timing difference.

6. The method of claim 5, wherein the downlink reception timing difference Δ=TP₂−TP₁+Δ_{N}, and wherein TA=TA′+Δ=2TP₂.

7. The method of claim 1, wherein the RACH procedure is a contention free random access (CFRA) procedure, and wherein CFRA preambles and resources are configured and triggered by a radio resource control (RRC) signaling or by a physical downlink control channel (PDCCH) order.

8. The method of claim 1, wherein a single RACH attempt contains multiple RACH preamble transmissions over multiple RACH occasions.

9. The method of claim 1, wherein common RACH occasion (CRAO) is configured to the UE such that a single preamble transmission is received by multiple cells.

10. The method of claim 9, wherein the CRAO is configured based on UE capability and measurements.

11. A User Equipment (UE), comprising:
a receiver that receives a configuration in a serving cell of a mobile communication network, wherein the configuration comprises information for performing an early random access channel (RACH) procedure with a neighbor cell;
a control circuit that obtains a downlink reception timing difference Δ between the serving cell and the neighbor cell;
a RACH handling circuit that transmits a RACH preamble to the network, wherein the UE obtains an estimated timing advance of the neighbor cell (TA′) derived from a random access response (RAR) from the neighbor cell; and
a synchronization circuit that acquires a timing advance of the neighbor cell (TA) by adjusting the estimated timing advance of the neighbor cell (TA′) using the downlink reception timing difference Δ, wherein TA=TA′+Δ.

12. The UE of claim 11, wherein the downlink reception timing difference Δ is equal to a propagation delay of the neighbor cell (TP₂) minus a propagation delay of the serving cell (TP₁).

13. The UE of claim 12, wherein the estimated TA of the of the neighbor cell TA′=TP₁+TP₂ and the downlink reception timing difference Δ=TP₂−TP₁, if the serving cell and the neighbor cell are synchronized.

14. The UE of claim 13, wherein the TA of the neighbor cell can be obtained from TP₁ and Δ without relying on the RAR from the neighbor cell, wherein TA=2TP₁+2A.

15. The UE of claim 12, wherein the estimated TA of the of the neighbor cell TA′=TP₁+TP₂−Δ_{N} if the serving cell and the neighbor cell are not synchronized, and Δ_{N} is the network timing difference.

16. The UE of claim 15, wherein the downlink reception timing difference Δ=TP₂−TP₁+Δ_{N}, and wherein TA=TA′+Δ=2TP₂.

17. The UE of claim 11, wherein the RACH procedure is a contention free random access (CFRA) procedure, and wherein CFRA preambles and resources are configured and triggered by a radio resource control (RRC) signaling or by a physical downlink control channel (PDCCH) order.

18. The UE of claim 11, wherein a single RACH attempt contains multiple RACH preamble transmissions over multiple RACH occasions.

19. The UE of claim 11, wherein common RACH occasion (CRAO) is configured to the UE such that a single preamble transmission is received by multiple cells.

20. The UE of claim 19, wherein the CRAO is configured based on UE capability and measurements.
